(19) United States
(12) Patent Application Publication
(10) Pub. No.: US 2004/0088214 A1
(43) Pub. Date: May 6, 2004

(54) Multi-dimensional voting

(76) Inventors: Joerg Beringer, Frankfurt (DE); Michael Hatscher, Osanbrueck (DE); Dennis B. Moore, Burlingame, CA (US)

Correspondence Address: FINNEGAN ,HENDERSON, FARABOW, GARRETT & DUNER , LLP, 1300 I STREET N.W., WASHINGTON ,, DC, 20005-3315, US

(21) Appl. No.: 10/285,280

(22) Filed: Oct. 31, 2002

(51) Int. Cl. G06F 17/60

(52) U.S. Cl. 705/12

(57) ABSTRACT

Systems and techniques to gather feedback or other information using a multi-dimensional voting system. In general, in one implementation, the technique includes presenting a voting space having multiple dimensions including a first dimension associated with a first proposition and a second dimension associated with a second proposition. A voter is enabled to select a location within the voting space, the selected location representing a unique combination of a first proposition value and a second proposition value. A record is made of the first proposition value as a vote relative to the first proposition and the second proposition value as a vote relative to the second proposition. Optionally, enabling voters to select a location in the voting space and recording the corresponding votes may be repeated. A distribution of the recorded proposition values in the voting space subsequently may be displayed.

### BACKGROUND

The following description relates to gathering feedback or other information using a multi-dimensional voting system. Techniques have been developed to help determine people's preferences. The information gathered may be used for varied purposes including commercial reasons to predict consumer behavior, societal beliefs and corporate strategies.

One technique for assessing a person or group view is a questionnaire, in which a person completing the questionnaire answers one or more questions concerning some aspect of the information desired. In one type of questionnaire, the person may select a response to a question from a group of proffered responses. In this context, a person may be said to have “voted” for a particular response.

A survey may be used to canvass voters' views on a proposition. A series of questions may be proffered concerning a proposition of interest. For example, a survey may include questions designed to elicit a voter's sentiment on a topic of interest to the canvasser.

In a survey or questionnaire a voter may be allowed a single response to a question. The response may, for example, be “yes” or “no.” Some surveys may be arranged so that a voter may select from a range of values. For example, the voter may be asked to select a numeric value from a range of values (e.g., 1 to 10) or a qualitative value, for example, a statement that best reflects the voter's sentiment on a question or proposition.

Techniques such as “scatterplots” have been developed where a relationship is suspected between two propositions. A scatterplot is a summary of a set of bivariate data. A graphical plot is made of a dependent variable against an independent variable where the values of the independent and dependent variables describe the location of a point in the scatterplot. For example, the weight of a person may be plotted as a dependent variable of the person's height. Each person who supplies his or her height and weight represents the weight/height coordinates of one point on the scatterplot. The distribution of the resulting pattern of points can provide a visual indication of a relationship between the two variables and may provide information about the strength of the relationship.

### SUMMARY

The present application teaches systems and techniques for gathering information using multi-dimensional voting.

In one aspect, gathering feedback from voters is facilitated by associating a first range of values with a first proposition and a second range of values with a second proposition independent of the first proposition, presenting a voting space having a plurality of locations, each location corresponding to a unique coordinate of first and second proposition values, enabling a voter to select a location in the voting space and recording the first and second proposition values corresponding to the selected location.

In another aspect, gathering feedback includes repeating the selection of locations and recording or values and subsequently displaying a distribution of the recorded proposition values in the voting space.

In another aspect, a feedback gathering technique includes presenting a voting space having a plurality of dimensions including a first dimension associated with a first proposition and a second dimension associated with a second proposition, enabling a voter to select a location within the voting space, the selected location representing a unique combination of a first proposition value and a second proposition value and recording the first proposition value as a vote relative to the first proposition and the second proposition value as a vote relative to the second proposition.

Other aspects include an article comprising a machine-readable medium storing machine-readable instructions that, when executed, cause a machine to perform the disclosed techniques, and/or a system that includes one or more computers configured to implement the disclosed techniques.

The systems and techniques described here may provide one or more of the following advantages. Information may be gathered from voters using without requiring voters to fill out a questionnaire. In various implementations, voters may be presented with, and select from, proposition values represented in different types of scales, e.g., a continuous value scale, a range of discrete values, and/or binary (e.g., yes/no) values. Some implementations present a vote density display that discriminates between voter segments or voter characteristics.

Details of one or more implementations are set forth in the accompanying drawings and the description below. Other features and advantages will be apparent from the description and drawings, and from the claims.

### DESCRIPTION OF DRAWINGS

These and other aspects will now be described in detail with reference to the following drawings.

FIG. 1 is a block diagram of a system that may be used to implement two-dimensional (2D) voting;

FIG. 2 is a flow chart of an implementation of 2D voting;

FIG. 3 illustrates a voting space according to one implementation;

FIG. 4 illustrates a voting space including a vote density display;

FIG. 5 is an alternative implementation of a voting space;

FIGS. 6A-6B illustrate a voting space display for two different voter segments; and

FIGS. 7A-7B illustrate a display of a cluster of votes in a voting space display.

Like reference symbols in the various drawings indicate like elements.

### DETAILED DESCRIPTION

The systems and techniques described here relate to gathering information using multi-dimensional voting. By selecting a single location in a voting space, a voter may give an indication of a preference for more than one proposition. A voting space having more than one dimension (e.g., two-dimensional (2D) or three-dimensional (3D)) may be presented to a voter. Each dimension of the voting space corresponds to a proposition. Values can be associated with each dimension such that each location in the voting space corresponds to a unique set of values of the propositions. By selecting a particular location in the voting space, a voter may indicate a value for each of the propositions.

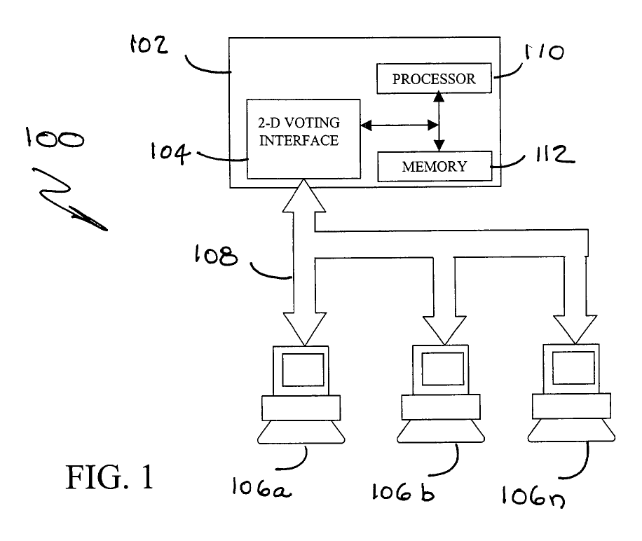

FIG. 1 illustrates a block diagram of a computer system 100 that may be used to implement multi-dimensional voting. The system includes a host server 102 including 2D voting interface software 104 that may accessed by a voter using computer devices 106a, 106b, . . . 106n over a network 108.

In an exemplary implementation, the voting software 104 can present a voter with a display of a 2D voting space. The particular voting space to be presented by the software may be determined by, for example, the host server using known characteristics of the voter's identity. In another implementation, the voter may select a desired voting space or the presented voting space may be selected at random.

The host server 102 may include, for example, a processor 110 and a memory 112. The memory 112 may be configured to include a database for use by the host server to store and retrieve information related to the operation of the host server including execution of the 2D voting software to present the voting space display to the voter. The memory may be used to operate on vote values received from multiple voters and to display or otherwise provide output associated with the votes. The network 108 may include a plurality of devices such as servers, routers and switching elements connected in an intranet, extranet or Internet configuration.

The voter may use a computer device, such as computer 106a, to access the host server 102 over the network 108. The computer device 106a may include a personal computer (PC), personal digital assistant (PDA) or other device using wireless or wired communication protocols to access the host server 102. The computer device 106a may be coupled to I/O devices (not shown) that may include a keyboard in combination with a pointing device such as a mouse to input data into the computer, a computer display screen and/or a printer to produce output from the computer, a storage resource such as a hard disk drive for storing and retrieving data for the computer, and/or other I/O devices.

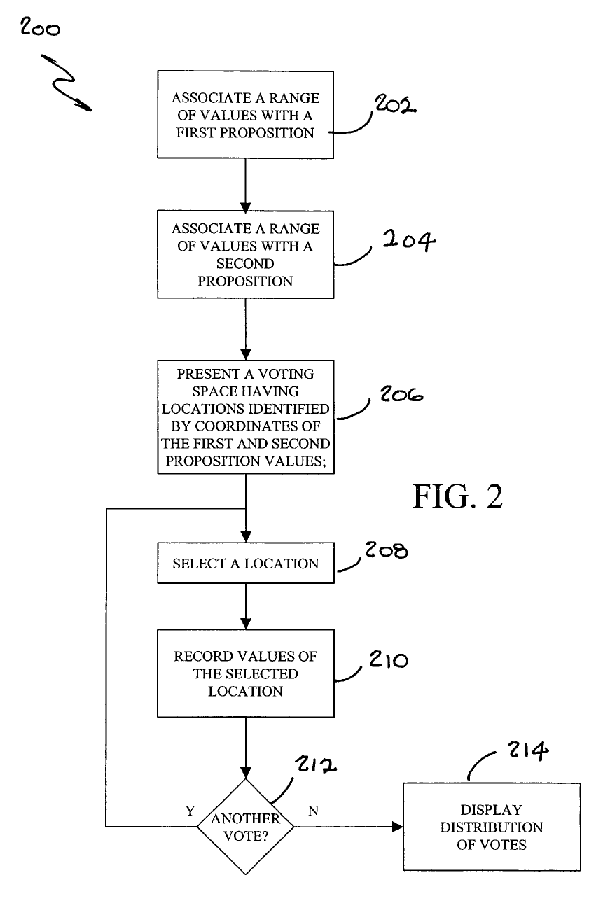

FIG. 2 is a flow chart 200 of an implementation of 2D voting. Propositions are determined upon which voter preferences are sought. The propositions may include, for example, a trait, a quality, a feature, a question or any characteristic where a voter's opinion may be desired. The propositions include commercial usages, such as for marketing, and non-commercial uses, such as for company methodology or voter sentiment. A range of values is associated 202 with a first proposition and a range of values is associated 204 with a second proposition. The range of values may be qualitative or quantitative and may range from a starting or minimum value towards a final or maximum value. For example, the range of values may include binary pairs such as “no” or “yes,” or a range of discrete values such as ordinal numbers from 0 to 10, or a continuous scale such as “like” to “dislike.” The first and second propositions may be related or independent. The relationship, if any, between the propositions need not be known before votes are recorded.

A voting space may be presented 206 having coordinates of values of the first and second propositions. In an implementation, the first and second propositions represent orthogonal axes of the voting space. Each location in the voting space may correspond to unique coordinates of the first and second proposition values. A voter selects 208 a location in the voting space. The first proposition value and second proposition corresponding to the selected location are recorded 210. If additional votes are entered 212, a location is selected 208 by a voter and the corresponding first and second proposition values recorded 210 as before. In some implementations, a voter may be allowed to have only one vote.

Votes are collected by repeating the selecting and recording until the voting is completed. A distribution of the votes may be displayed 214. In an implementation, the distribution is displayed in the voting space as a variation in the color or hue representing a vote density. For example, the depth of hue may be used to indicate the frequency of selection of a location in the voting space.

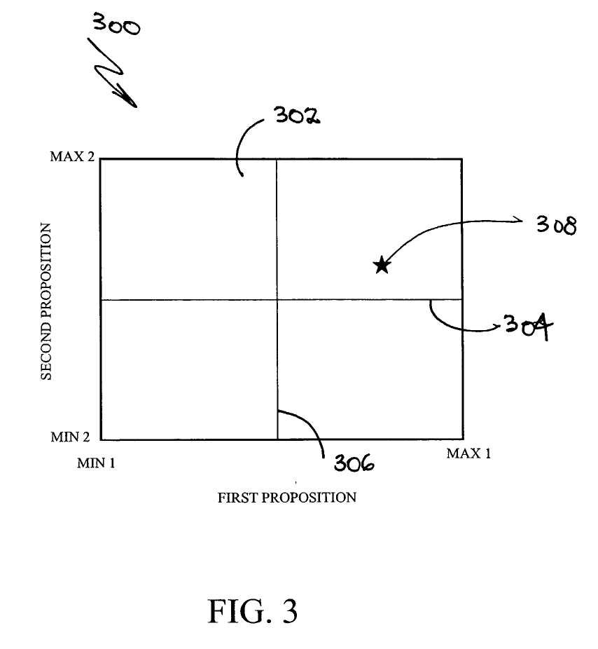

FIG. 3 illustrates a presentation 300 of a voting space according to one implementation. In this implementation the voting space 302 is shown generally as being rectangular, although the voting space's shape can be other than rectangular. The first proposition may be represented by a horizontal axis 304 and the second proposition by a vertical axis 306. First proposition axis 304 and second proposition axis 306 have minimum values Min1, Min2 and maximum values Max1 and Max2, respectively. In the illustrated embodiment, the axes are shown as centered in the voting space but they can be position elsewhere in the space as desired. A voter's selected location (or vote) 308 may be visually differentiated from the voting space by any convenient method including display of an icon, color or hue.

As an example, suppose voters' opinions on a lecture are sought. A first proposition might be, “Was the lecture useful for me?” and the associated values range from a Min 1 of “no” to a Max1 of “yes.” A second proposition might be, “How interesting was the subject matter?” and the associated values range from Min2 of “dull” to a Max2 of “fascinating.”

In another example, 2D voting may be used to survey a class of voters without using a questionnaire. Sales employees may be asked to value a first proposition of, “There is good communication between sales and marketing” having a range of values from “agree” to “disagree” and a second proposition of, “I get information from marketing” having a range of values from “a lot” to “a little.”

Hyperlinks may be provided for specific areas of the voting presentation 300. For example, a link may be provided between the propositions and a detailed description of the proposition including the context, time limit for voting, meaning of the proposition values, or other helpful descriptions. The voting presentation may include legends such as minimum and maximum range values.

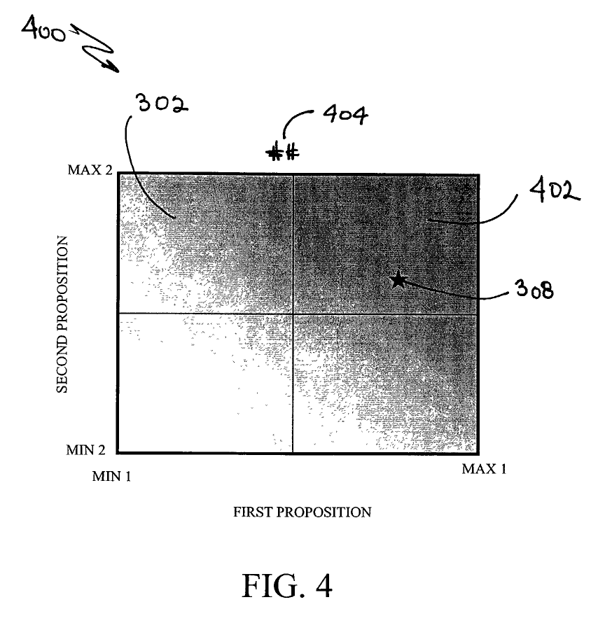

FIG. 4 illustrates a presentation 400 of a voting space 302 having a vote density display 402. In the implementation illustrated, the areas of darker shading correspond to locations in the voting space that received a greater density of votes. A voter's vote 308, distinguished from the vote density 402, may be displayed when the vote density is displayed. In this implementation, the voter's vote may be judged against the distribution of all other voters. A total number of votes recorded 404 also may be displayed. The vote density may reveal a previously unknown relationship between the propositions.

In some implementations, the vote density display 402 may be displayed while a voter is voting. In other implementations the vote density may be revealed to voters only after their vote has been recorded. In yet other implementations, the vote density display may be refreshed continuously as votes are recorded, at predetermined time intervals or after a predetermined incremental increase in the number of votes recorded.

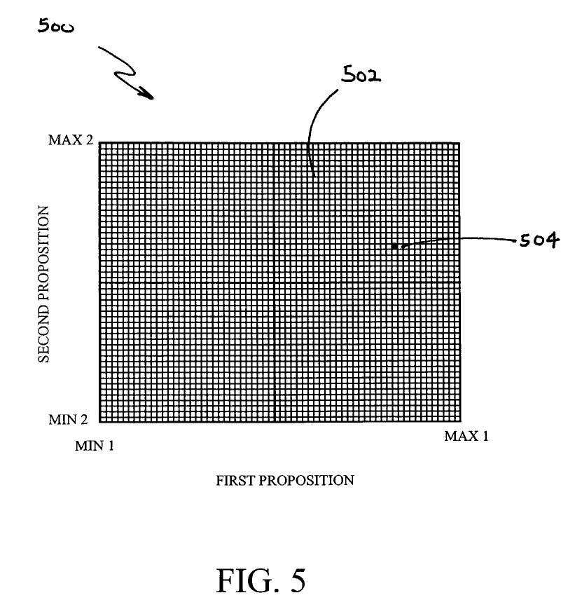

FIG. 5 illustrates an implementation where a voting space display 500 is rendered as rectangular voting locations 502. The voting locations tessellate the voting space. A voter's vote may be a selection of one of the voting locations. The voting space can be rendered by displaying all of the rectangular voting locations. A voter's vote is displayed by substituting a corresponding voting location with a voting marker 504. This implementation has an advantage that it may simplify computation of a voting density. The implementation may also have advantageous use where voters' votes are in incremental steps. For example, a proposition such as, “How many people are in your department?” may be meaningful only in increments of whole numbers.

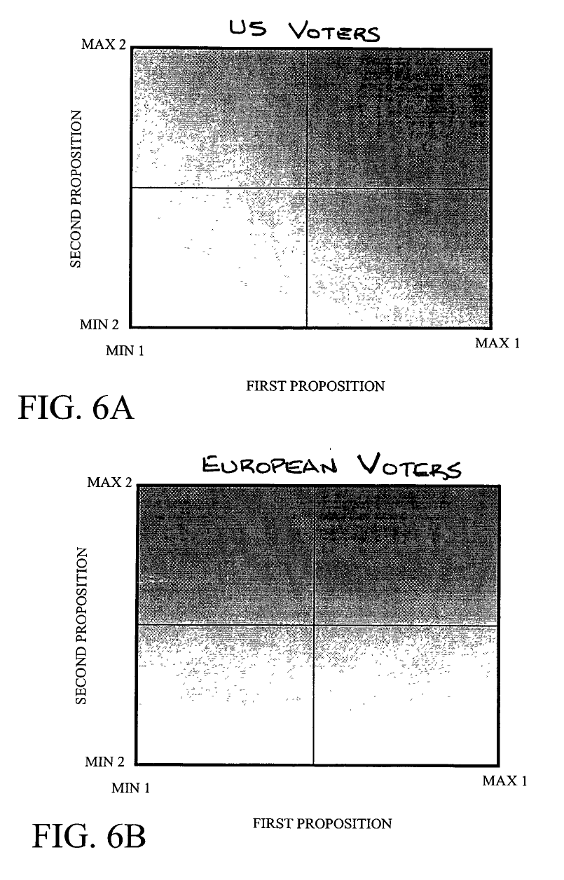

FIGS. 6A and 6B illustrate segmentation of the voting density display. The voting density may be displayed for different voter segments. The voting segment selected is not limited and includes voters segmented by job role, income level, location or other cognizable voter feature. Display of the voting density by various voter segments may reveal a relationship between the segment of voters and the resulting density or, perhaps, distinguish voter segment preferences from other voter segment preferences. For example, FIGS. 6A and 6B could illustrate a voting density difference between a U.S. voter segment and a European voter segment voting on the same first and second propositions. The voting density, in this example, seems to reveal that while both the U.S. and European voter segments tended towards a maximum value for a first proposition, the European voters seem to give a greater value to the second proposition than the U.S. voters. Such voter segmentation may provide discrimination between voter segments and identify voter characteristics.

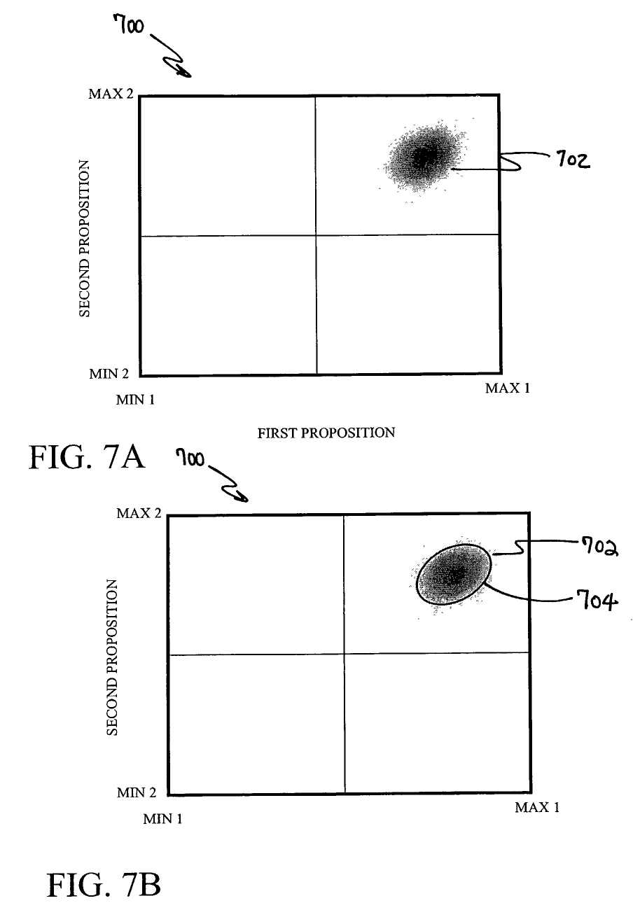

FIG. 7A illustrates a clustering of votes 700 from all voters or from a voting segment. In some implementations, features or characteristics of the voters may be used to define a segment where the votes are clustered. For example, a characteristic of a segment of the voters may be Germans between the ages of 17-25. Selecting this characteristic may result in the cluster 702. The features of the voters may be selected manually or

FIG. 7B illustrates the clustering of FIG. 7A where the cluster is demarked. One or more clusters may be distinguished from the entire display by, for example, a line 704 around the cluster. The line may encompass all or part of the cluster. In the illustrated example, the line 704 surrounds the core of the clustered votes. In other implementations, the cluster may be distinguished from the display of all votes, and if desired other clusters, by hue or brightness. In yet other implementations, one or more of the demarked clusters may be displayed at the same time as the entire display.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. The logic flow depicted in FIG. 2 does not require the particular order shown, or sequential order, to achieve desirable results. For example, recording values of the selected location may be performed at many different places within the overall process. In certain implementations, multitasking and parallel processing may be preferable.

Other embodiments are within the scope of the following claims.

What is claimed is:

1. A method comprising:
associating a first range of values with a first proposition and a second range of values with a second proposition independent of the first proposition;
presenting a voting space having a plurality of locations, each location corresponding to a unique coordinate of first and second proposition values;
enabling a voter to select a location in the voting space; and
recording the first and second proposition values corresponding to the selected location.

2. The method of claim 1 comprising:
repeating the selecting and recording; and
subsequently displaying a distribution of the recorded proposition values in the voting space.

3. The method of claim 2 further comprising averaging the recorded proposition values.

4. The method of claim 1 wherein the voting space is tessellated by rectangular shaped locations.

5. The method of claim 1 comprising providing a link to information on the propositions.

6. The method of claim 1 comprising:
displaying a first axis corresponding to the first proposition;
displaying, orthogonal to the first axis, a second axis corresponding to the second proposition; and
displaying on each axis a minimum and maximum value for the first and second propositions' respective range of values.

7. The method of claim 3 wherein displaying the distribution further comprises visually differentiating the displayed average values from the voting space using at least one of hue and brightness.

8. The method of claim 1 wherein the selected location is visually distinguishable from unselected voting space locations by at least one of hue and brightness.

9. The method of claim 8 comprising limiting the number of locations that the voter is allowed to select.

10. The method of claim 2 comprising limiting the displayed distribution to the recorded proposition values of a segment of voters having a shared characteristic.

11. The method of claim 10 comprising displaying one or more clustered distributions of votes.

12. The method of claim 11 wherein both the displayed clustered distribution and the displayed distribution of all votes are displayed together.

13. The method of claim 12 comprising visually demarking the displayed clustered distribution of votes by at least one of hue, brightness or a border around some or all of the cisplayed cluster of votes.

14. A method of gathering feedback, the method comprising:
presenting a voting space comprising a plurality of dimensions including a first dimension associated with a first proposition and a second dimension associated with a second proposition;
enabling a voter to select a location within the voting space, the selected location representing a unique combination of a first proposition value and a second proposition value; and
recording the first proposition value as a vote relative to the first proposition and the second proposition value as a vote relative to the second proposition.

15. An article comprising a machine-readable medium storing instructions operable to cause one or more machines to perform operations comprising:
associate a first range of values with a first proposition and a second range of values with a second proposition independent of the first proposition;
present a voting space having a plurality of locations, each location corresponding to a unique coordinate of first and second proposition values;
enable a voter to select a location in the voting space; and
record the first and second proposition values corresponding to the selected location.

16. The article of claim 15 comprising instructions to:
repeat the selecting and recording; and
subsequently display a distribution of the recorded proposition values in the voting space.

17. The article of claim 16 further comprising instructions to average the recorded proposition values.

18. The article of claim 16 wherein the voting space is tessellated by rectangular shaped locations.

19. The article of claim 15 comprising instructions to provide a link to information on the propositions.

20. The article of claim 15 comprising instructions to:
display a first axis corresponding to the first proposition;
display, orthogonal to the first axis, a second axis corresponding to the second proposition; and
display on each axis a minimum and maximum value for the first and second propositions' respective range of values.

21. The article of claim 17 wherein display of the distribution further comprises instructions to visually differentiate the displayed average values from the voting space using at least one of hue and brightness.

22. The article of claim 15 wherein the selected location is visually distinguishable from unselected voting space locations by at least one of hue and brightness.

23. The article of claim 22 comprising instructions to limit the number of locations that the voter is allowed to select.

24. An article comprising a machine-readable medium storing machine-executable instructions that, when executed, cause a machine to perform operations comprising:
present a voting space comprising a plurality of dimensions including a first dimension associated with a first proposition and a second dimension associated with a second proposition;
enable a voter to select a location within the voting space, the selected location representing a unique combination of a first proposition value and a second proposition value; and
record the first proposition value as a vote relative to the first proposition and the second proposition value as a vote relative to the second proposition.

25. The article of claim 15 comprising instructions to:
repeat the selecting and recording; and
subsequently display a distribution of the recorded proposition values in the voting space.

26. A system for gathering information, the system comprising one or more computers configured to:
associate a first range of values with a first proposition and a second range of values with a second proposition independent of the first proposition;
present a voting space having a plurality of locations, each location corresponding to a unique coordinate of first and second proposition values;
enable a voter to select a location in the voting space; and
record the first and second proposition values corresponding to the selected location.

27. The system of claim 26 comprising the computers configured to:
repeat the selecting and recording; and
subsequently display a distribution of the recorded proposition values in the voting space.

28. A system for gathering information, the system comprising one or more computers configured to:
present a voting space comprising a plurality of dimensions including a first dimension associated with a first proposition and a second dimension associated with a second proposition;
enable a voter to select a location within the voting space, the selected location representing a unique combination of a first proposition value and a second proposition value; and
record the first proposition value as a vote relative to the first proposition and the second proposition value as a vote relative to the second proposition.

29. The system of claim 28 comprising instructions to:
repeat the selecting and recording; and
subsequently display a distribution of the recorded proposition values in the voting space.
